(19) United States
(12) Patent Application Publication
(10) Pub. No.: US 2007/0203783 A1
(43) Pub. Date: Aug. 30, 2007

(54) Market simulation model

(76) Inventor: Mark A. Beltramo, Grosse Ile, MI (US)

Correspondence Address: KATHRYN A MARRA;General Motors Corporation, Legal Staff, Mail Code 482-C23-B21, P.O. Box 300, Detroit, MI, 48265-3000, US

(21) Appl. No.: 11/710,139

(22) Filed: Feb. 23, 2007

Related U.S. Application Data
(60) Provisional application No. 60/776,333, filed on Feb. 24, 2006.

(51) Int. Cl. G07G 1/00; G06F 17/30

(52) U.S. Cl. 705/10

(57) ABSTRACT

Methods and computer program products for providing a market simulation model. A method includes receiving consumer data including one or more ratings of a product characteristic, the ratings reflecting a latent measure of the product characteristic. The ratings are represented as a probability distribution. The latent measure of the product characteristic is varied and an updated probability distribution is created in response to the varying. A sensitivity of market share to the product characteristic is analyzed based on the probability distribution and to the updated probability distribution.

### CROSS-REFERENCE TO RELATED APPLICATIONS

The present application claims the benefit of provisional application No. 60/776,333 filed Feb. 24, 2006, the content of which is herein incorporated by reference in its entirety.

### BACKGROUND

Exemplary embodiments relate generally to a market simulation model, and more particularly, to methods and computer program products for incorporating subjective product characteristics into a market simulation model.

Models for predicting the market success of consumer products require the ability to characterize the products in terms of product characteristics and the consumers in terms of their preferences for those characteristics. In many cases, product designers want to characterize products in terms of physical attributes they can manipulate (e.g., decibels of noise in a wind tunnel), but for some characteristics perceived performance is subjective and variable (e.g., noise level in a vehicle, vehicle ride).

Current market simulation processes are conducted to determine which product characteristics are most important to consumers. These processes assume that all consumers have the same perception of a product's performance on all characteristics. In addition, current market simulation processes represent subjective characteristics by a single value, such as their average perceived value. It would be desirable to be able to represent subjective characteristics by the distribution of their perceived levels among consumers while allowing preferences for levels of product characteristics to be nonlinear and to vary among consumers. Further, it would be desirable to utilize an algorithm (e.g., based on a latent variable statistical model) for analyzing the sensitivity of market share to the distribution of subjective characteristics. This would lead to a more accurate assessment of consumer preferences for particular product characteristics.

### SUMMARY

Exemplary embodiments relate to methods and computer program products for providing a market simulation model. A method includes receiving consumer data including one or more ratings of a product characteristic, the ratings reflecting a latent measure of the product characteristic. The ratings are represented as a probability distribution. The latent measure of the product characteristic is varied and an updated probability distribution is created in response to the varying. A sensitivity of market share to the product characteristic is analyzed based on the probability distribution and to the updated probability distribution.

Other exemplary embodiments include a method for performing market simulation. The method includes receiving consumer data. The consumer data includes one or more ratings of a product characteristic. The ratings reflect a latent measure of the product characteristic. The ratings are represented as a probability distribution. A change to the latent measure of the product characteristic is calculated based on a specified change to a top-box proportion of the probability distribution or based on a specified change to a mean observed rating of the product characteristic. Both low and high distributions of the data are calculated in response to the calculated change in the latent measure. A change in product share caused by the change in the latent measure of the product characteristic is then calculated based on the low and high distributions of the data.

Further embodiments include a computer program product for modeling a supply chain. The computer program product includes a storage medium readable by a processing circuit and storing instructions for execution by the processing circuit for performing a method. The method includes receiving consumer data including one or more ratings of a product characteristic, the ratings reflecting a latent measure of the product characteristic. The ratings are represented as a probability distribution. The latent measure of the product characteristic is varied and an updated probability distribution is created in response to the varying. A sensitivity of market share to the product characteristic is analyzed based on the probability distribution and to the updated probability distribution.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES;

FIG. 1 depicts an individual's utility function for quietness and the distribution of perceived quietness for two vehicles;

FIG. 2 depicts an exemplary distribution of perceived performance for a ride characteristic;

FIG. 3 depicts a process for performing market simulation that may be implemented by exemplary embodiments;

FIG. 4 depicts a process for performing market simulation that may be implemented by exemplary embodiments; and

FIG. 5 depicts a system for performing market simulation that may be implemented by exemplary embodiments.

### DETAILED DESCRIPTION

Exemplary embodiments described herein relate to market simulation for product attributes that are referred to as “subjective performance attributes.” Subjective performance attributes are product attributes that are measured by the subjective perceptions of each customer, not by an objective physical measurement. The interior quietness of a vehicle is an example of a subjective performance attribute; interior quietness is difficult to measure because what one person regards as a quiet noise level in a vehicle may be thought to be a loud noise level by another person. Examples of subjective performance attributes for automotive products include, but are not limited to, ease of entry and exit, interior quietness, ride softness/stiffness, driver seat comfort, roominess, acceleration, brake pedal feel, responsiveness of braking, handling on curves and visibility. Exemplary embodiments described herein represent the level of a subjective product characteristic by the distribution of its perceived level among consumers and include an algorithm for analyzing the sensitivity of market share to the distribution of subjective characteristics. Thus, exemplary embodiments may be utilized to be able to better differentiate between alternate product designs in terms of the market appeal of their subjective characteristics.

In exemplary embodiments, a product's performance on a subjective attribute is represented by the distribution of customer ratings on a descriptive verbal scale. If the consumer's utility for each level of the verbal scale is estimated but it is not known how the consumer perceives the product's performance on that attribute, then the ratings distribution is utilized to calculate the expected value of the consumer's utility for the product's performance. Further, with some additional assumptions, the sensitivity of a market simulator's predictions to changes in a product's perceived performance are measured, even when perceived performance is described by a distribution of consumer ratings.

Exemplary embodiments represent subjective characteristics by the distribution of their perceived levels among consumers while allowing preferences for levels of product characteristics to be nonlinear and to vary among consumers. Further, exemplary embodiments utilize an algorithm (based, for example, on a latent variable statistical model) for analyzing the sensitivity of market share to the distribution of subjective characteristics. Thus, exemplary embodiments may be utilized to provide more accurate assessments (when compared to existing market simulation processes) of consumer preferences for particular product characteristics. Product updates can then be focused on improving those product characteristics whose changes are most likely to attract new customers and/or to retain existing customers.

Exemplary embodiments are designed for subjective performance attributes that can be measured using an ordinal scale (ordinal in terms of the product's performance on some underlying attribute). As a product's performance on a subjective attribute moves in one direction (e.g., from a vehicle's soft ride to firm ride), exemplary embodiments assume that any individual's perception of the product's performance on that attribute will move in the same direction. That is, the verbal rating is assumed to be a monotonic function of perceived performance on some continuous, unobserved performance measure (e.g., a latent measure). An individual's utility, or preference, for the product's performance may increase or decrease with changes in product performance, depending on the individual's preferences regarding the direction in which performance is moving. In exemplary embodiments, the rating scales measure perceived performance, not preference.

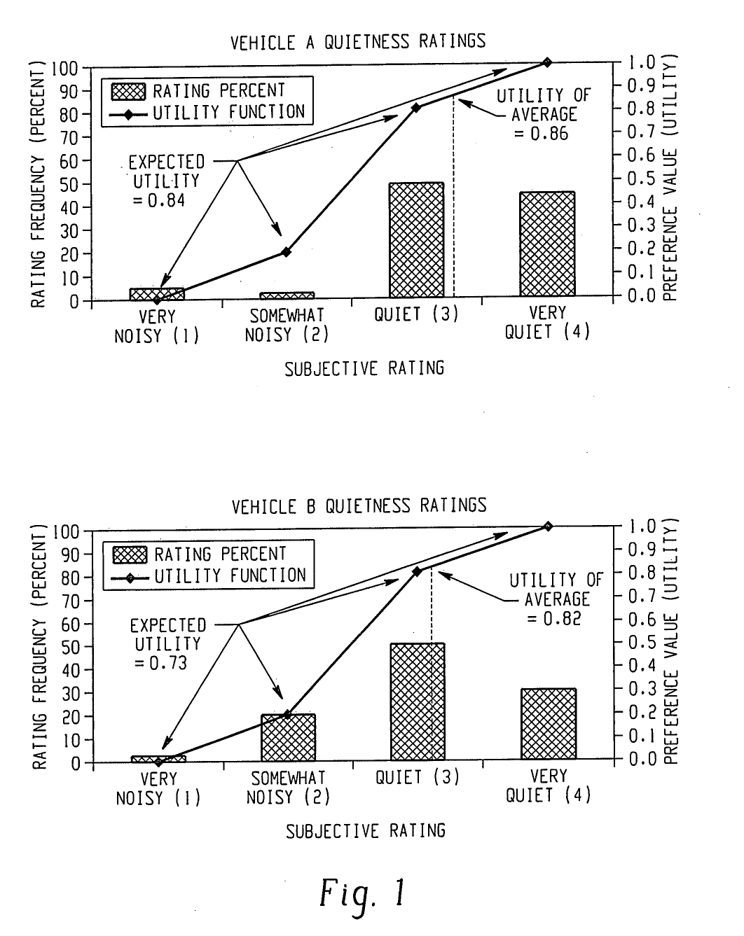

FIG. 1 depicts an individual's utility function (or preference function) for quietness and the distribution of perceived quietness for two vehicles (A and B). Conventional simulation processes interpolate the utility of the average rating, yielding 0.86 for A and 0.82 for B. The correct expected utility is a weighted average of the utilities for each rating level (shown by the heights of the diamonds on the utility scale), where the weights are the probabilities of each rating level (shown by the heights of the bars on the rating frequency scale). The correct expected utilities are 0.84 for A and 0.73 for B. Thus, using conventional processes, the difference in expected utility (or expected consumer preference) between these vehicles is understated by a factor of three. This is due to the steep drop in preference between “quiet” and “somewhat noisy.” The improved method described herein provides a better estimate by identifying the large difference in expected preference, between quiet and somewhat noisy, and estimating a lower probability of an individual preferring vehicle B than that estimated by the conventional processes.

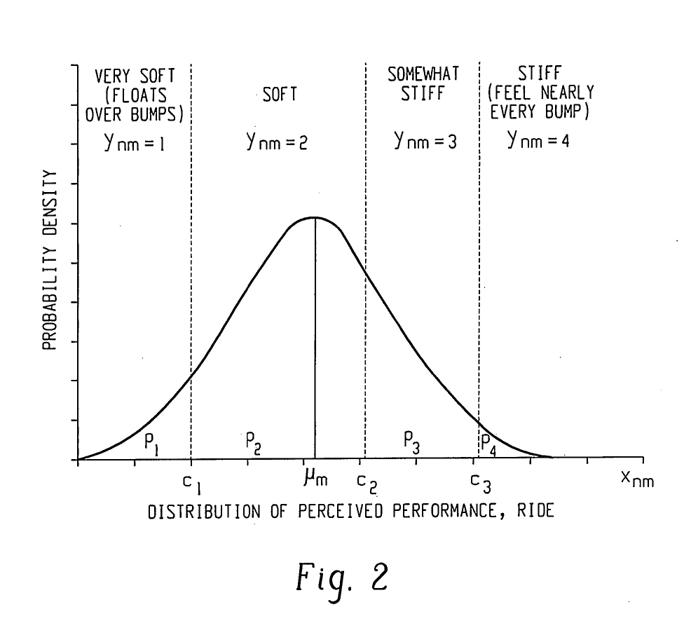

FIG. 2 illustrates how the n^{th} consumer's rating process for the m^{th} vehicle is viewed. The consumer evaluates an attribute of the product (here, vehicle ride) on an unobserved, continuous scale. His rating on this continuous scale is called his latent rating. He assigns the product a rating on the survey's verbal scale according to where the latent rating falls relative to, several thresholds, or cut points. For example, if the consumer's latent rating falls between c₁ and c₂ in FIG. 2, then he selects “soft” on the verbal scale and the response variable yₙₘ is assigned a value of 2.

Because the attribute is subjective, the perceived performance of the same product may differ among consumers. The distribution of consumers' latent ratings, or latent perceived performance, is shown in FIG. 2 for the vehicle ride example. The mean of the latent perceived performance distribution is denoted by μₘ. The proportion of consumers assigning the vehicle a rating of “soft,” for example, is p₂, the area under the probability density curve between c₁ and c₂. This is also the probability that an individual respondent will select a rating of “soft.” Exemplary embodiments utilize a formula for translating changes in mean latent perceived performance (μₘ) into changes in the distribution of observed performance ratings among consumers. Table 1, below, defines the notation used to describe the approach utilized by exemplary embodiments to analyze a subjective performance attribute.

FIG. 2 depicts one model of a probability distribution that may be implemented by exemplary embodiments. As known by those skilled in the art, the probability distribution may be modeled in any number of manners while still providing the required data to perform the functions described herein. For example, the probability distribution may contain discrete values (instead of the continuous values depicted in FIG. 2). In another alternative, the probability distribution includes continuous values but has a different shape than the curve depicted in FIG. 2. In addition, the manipulations performed to the probability distribution described herein are intended to be exemplary in nature and any manipulations known by those skilled in the art to perform the functions described herein may be implemented by exemplary embodiments. For example, an exemplary embodiment could calculate the change in the latent mean performance required to achieve a predetermined change in the proportion of consumers giving the product an extreme rating. This would allow measuring the sensitivity of the market model's predictions to changes in this proportion.

In exemplary embodiments, the data includes \hat{p}ₘ, the vector of rating proportions for the verbal survey scale. These proportions are sample estimates of the probabilities shown in FIG. 2. Since F is known and \hat{p}ₘ is observed, the formula in Table 1 is utilized to calculate zₘₖ, an estimate of the difference \tilde{c}ₖ−\tilde{μ}ₘ, where \tilde{c}ₖ and \tilde{μ}ₘ denote a cut point and mean that have been divided by the standard deviation of the latent rating distribution (e.g., the distribution shown in FIG. 2). Again, see Table 1 for exemplary detailed formulas. Thus, zₘₖ is measured in standard deviations of latent perceived performance.

Clearly, a shift in the mean perceived performance, \tilde{μ}ₘ, implies a corresponding shift in zₘₖ and in each of the rating probabilities. For example, suppose that the mean perceived performance of product m increases by an amount, d. Then, each zₘₖ decreases by d, and the new ratings distribution can be calculated using the formula for pₘₖ in Table 1:
pₘₖ*=F(zₘₖ−d)−F(z_{m,k-1}−d), k=1, . . . , K. (1)

Hence, it is possible to smoothly vary the ratings probabilities by varying a single parameter: \tilde{μ}ₘ, or mean latent perceived performance. Next, an appropriate range over which to vary \tilde{μ}ₘ (an example of a latent measure of a product characteristic) must be specified for the purpose of sensitivity analysis.

TABLE 1
Mathematical notation and definitions

| Symbol | Description |
|---|---|
| M | Number of products in database, |
| | indexed by m = 1, . . . , M. |
| K | Number of attribute rating levels, k = 1, . . . , K. |
| yₙₘ | Rating given by respondent n to product m; |
| | yₙₘ ∈{1, 2, . . . , K} |
| xₙₘ | Performance of product m perceived by |
| | respondent n (xₙₘ is unobserved). |
| cₖ | k^{th} cut-point (response threshold). The response |
| | thresholds determine how unobserved perceived |
| | performance, xₙₘ, is translated into the observed |
| | performance rating, yₙₘ. Specifically, yₙₘ = k if |
| | and only if cₖ₋₁ < xₙₘ <= cₖ, k = 1, . . . , K. |
| | (Here defining c₀ = −∞, c_{K} = ∞) See FIG. 2. |
| | Consumers are assumed to use the same |
| | cut-points in selecting their ratings. |
| μₘ | Mean perceived performance of product m |
| | among owners of product m. This is the expected |
| | value of xₙₘ. |
| Σ | Standard deviation of perceived performance |
| | among owners of all products. Assumed the same |
| | for all consumers. |
| F | Cumulative distribution function (cdf) of |
| | (xₙₘ − μₘ)/σ. That is, |
| | $F ( z ) = Pr [ \frac{{x}_{nm} - {μ}_{m}}{σ} \leq z ] .$ |
| | F is assumed known and common to all products. |
| | It describes the shape of the distribution of |
| | perceived performance among consumers. |
| | Obvious choices for F are the standard Normal or |
| | the standardized logistic. (The standardized |
| | logistic distribution is the logistic distribution |
| | scaled to have unit variance; it is very similar to |
| | the standard Normal distribution.) |
| \tilde{x}ₙₘ = xₙₘ/σ | Normalized performance of product m as |
| | perceived by respondent n, measured in standard |
| | deviations of perceived performance. |
| \tilde{c}ₖ = cₖ/σ | k^{th} normalized cut-point, measured in standard |
| | deviations of perceived performance. |
| \tilde{μ}ₘ = μₘ/σ | Normalized mean perceived performance of |
| | product m among owners of product m, measured |
| | in standard deviations of perceived performance. |
| pₘ = | Population distribution of responses for product m |
| (pₘ₁, pₘ₂, . . . , p_{mK})^{T} | among owners of product m. By the definitions |
| | of yₙₘ and F, |
| | $\begin{matrix}{p}_{mk} = F ( \frac{{c}_{k} - {μ}_{m}}{σ} ) - F ( \frac{{c}_{k - 1} - {μ}_{m}}{σ} ) \\ = \tilde{F} ( {\tilde{c}}_{k} - {\tilde{μ}}_{m} ) - F ( {\tilde{c}}_{k - 1} - {\tilde{μ}}_{m} )\end{matrix}$ |
| | See FIG. 2. |
| | $Note that {\sum }_{i = 1}^{k} {p}_{mi} = F ( {\tilde{c}}_{k} - {\tilde{μ}}_{m} ) .$ |
| | The sample distribution is denoted by |
| | \hat{p}ₘ = (\hat{p}ₘ₁, . . . , \hat{p}_{mK})^{T}. |
| \tilde{c}ₖ − \tilde{μ}ₘ, zₘₖ | k^{th} standardized cut-point: difference between |
| | cutpoint k and mean perceived performance of |
| | product m, measured in standard deviations of |
| | perceived performance. Estimated by |
| | ${z}_{mk} = {F}^{- 1} ( \frac{{\sum }_{i = 1}^{k} {\hat{p}}_{mi} + k ɛ}{1 + K ɛ} ) , where ε is a small$ |
| | positive number (say, ∈ = |
| | 0.001) used to prevent numerical problems. |
| Pₖ | ${P}_{k} = ( 1 / M ) {\sum }_{m = 1}^{M} {\sum }_{i = 1}^{k} {p}_{mi} , k = 1 , . . . , K - 1.$ |
| wₖ | wₖ = Pₖ(1 − Pₖ); |
| | weights used in estimating \tilde{c}ₖ and \tilde{μ}ₘ. |

In an exemplary embodiment, the appropriate range, d, is specified by first estimating \tilde{μ}ₘ for every product in the database given their ratings probabilities pₘ. It can be seen from equation (1) that the data allows zₘₖ to be computed for each product m and cut point k. Exemplary embodiments choose \tilde{c}ₖ and \tilde{μ}ₘ, k=1, . . . , K, and m=1, . . . , M, to minimize the weighted least square error in fitting the observed zₘₖ. That is, \tilde{c}ₖ and \tilde{μ}ₘ are chosen to minimize:

$$WSE = {\sum }_{k = 1}^{K - 1} {\sum }_{m = 1}^{M} {{w}_{k} [ {z}_{mk} - ( {\tilde{c}}_{k} - {\tilde{μ}}_{m} ) ]}^{2} \qquad ( 2 )$$

where wₖ=Pₖ(1−Pₖ) and Pₖ is the cumulative proportion of responses less than or equal to k, averaged over all products. The weight wₖ achieves its maximum value when Pₖ=0.5 and it equals zero if Pₖ=0 or Pₖ=1. This weighting formula places more importance on fitting those values of zₘₖ associated with cut points surrounded by most of the data, rather than those values determined by relatively small amounts of data.

The values of \tilde{c}ₖ and \tilde{μ}ₘ that minimize the Weighted Squared Error (WSE) in equation (2) are as follows:

$$\begin{matrix}{\hat{c}}_{k} = \frac{1}{M} {\sum }_{m = 1}^{M} {z}_{mk} + \frac{1}{M} {\sum }_{m = 1}^{M} {\hat{μ}}_{m} , k = 1 , … , K - 1 , & ( 3 ) \\ {\hat{μ}}_{m} = {\sum }_{k = 1}^{K - 1} {w}_{k}^{′} {\hat{c}}_{k} - {\sum }_{k = 1}^{K - 1} {w}_{k}^{′} {z}_{mk} , m = 1 , … , M , & ( 4 )\end{matrix}$$

where wₖ′=wₖ/Σₖ₌₁^{K-1}wₖ.

Equations (3) and (4) do not allow exemplary embodiments to separately estimate \tilde{c}ₖ and \tilde{μ}ₘ: Exemplary embodiments could add a constant to every cut point estimate ĉₖ and add the same constant to every product's mean latent perceived performance estimate \hat{μ}ₘ and both equations would still hold: that is, the implied value of WSE would be the same. Thus, an identifying restriction is added in order to separately estimate \tilde{c}ₖ and \tilde{μ}ₘ.

Since the latent rating has no natural unit of measure anyway, it is assumed that the average over all products in the data of the mean latent perceived performance ratings equals zero. Therefore following restriction is imposed:

$$\frac{1}{M} {\sum }_{m = 1}^{M} {\hat{μ}}_{m} = 0.$$

From equation (3), then,
ĉₖ= z̅ₖ, (5)
where z̅ₖ=(1/M)Σₘ₌₁^{M}zₘₖ.
Substituting from equation (5) into equation (4), the following formula is obtained for \hat{μ}ₘ:

$${\hat{μ}}_{m} = {\sum }_{k = 1}^{K - 1} {w}_{k}^{′} {\overline{z}}_{k} - {\sum }_{k = 1}^{K - 1} {w}_{k}^{′} {z}_{mk} , m = 1 , … , M , \qquad ( 6 )$$

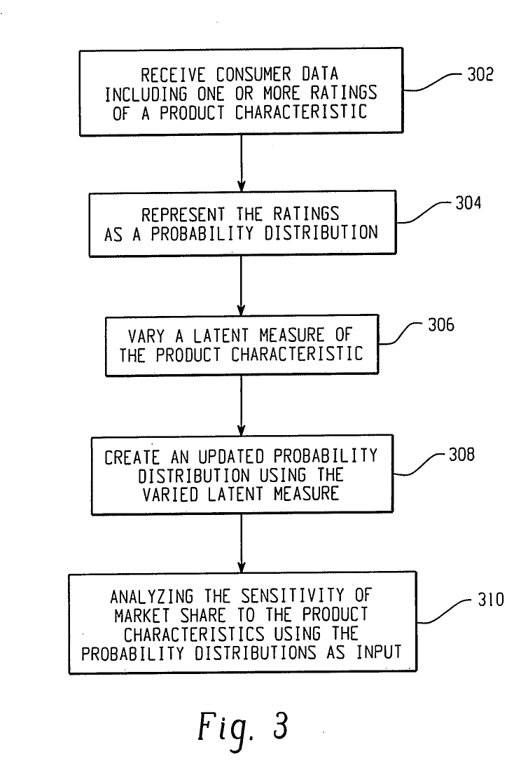

FIG. 3 depicts an exemplary process for performing market simulation using exemplary embodiments. In exemplary embodiments, this process is performed by market simulation software executing on a computer. At block 302, consumer data, including one or more ratings of a product characteristic, is received by the market simulation software. In this manner, the simulation software starts with a baseline database of product rating proportions, \hat{p}ₘ, m=1, . . . , M. This baseline reflects a latent measure of the product characteristic (e.g., a mean latent perceived performance). At block 304, the ratings are represented as a probability distribution that may be displayed on a user interface screen on a user device and/or stored in a database. This may be performed by computing zₘₖ and wₖ, m=1, . . . , M, k=1, . . . , K−1, using the appropriate exemplary formulas in Table 1. \hat{μ}ₘ, for m=1, . . . , M is computed as described in equation (6), above. For ease of interpretation, \hat{μ}ₘ, m=1, . . . , M, may be converted into performance scores:

$${S}_{m} = 100 * \frac{{\hat{μ}}_{m} - {\hat{μ}}_{min}}{{\hat{μ}}_{max} - {\hat{μ}}_{min}} ,$$

where \hat{μ}ₘᵢₙ is the minimum value and \hat{μ}ₘₐₓ is the maximum value of \hat{μ}ₘ among all products in the database. Thus, the best score among existing products is 100 and the worst score is 0. In exemplary embodiments, the performance scores Sₘ are made available to the user through the user interface. The user can refer to the distribution of scores within a product segment to assess what degree of improvement is plausible.

Next, at block 306, the latent measure of the product characteristic is varied by the market simulation software (e.g., based on user input from a user interface screen). In other words, for sensitivity analysis, the user varies Sₘ. If the score of vehicle m is changed by an amount D, then a new vector of rating proportions using equation (1) is computed, setting

$$d = \frac{D}{100} ( {\hat{μ}}_{max} - {\hat{μ}}_{min} ) .$$

At block 308, an updated probability distribution is created based on the varied latent measure. The updated probability distribution may be presented to a user via a user interface screen on a user device and/or saved to a database. At block 310, the market simulation software analyzes the sensitivity of the market share to the product characteristics by comparing the probability distribution generated at block 304 and the probability distribution generated at block 308 in view of the amount that the latent measure was varied. The results of the analyzing may be displayed to a user via a user interface screen, saved to a database and/or printed on a report.

In an alternate exemplary embodiment, a sensitivity analysis algorithm is derived that does not require the computation of \tilde{μ}ₘ. This algorithm is simpler to implement than the algorithm described previously in reference to FIG. 3. Several simulations can be performed based on this alternate sensitivity analysis algorithm. A first application is the derivation of d (the change in the latent variable) from a requested (or specified) change in the top-box proportion. The top-box proportion, as used herein, refers to the proportion of consumers giving the product an extreme rating. For example, the proportion of people rating a vehicle as “very quiet” in FIG. 1 is a top-box proportion. Another application is expressing the change in product share caused by changing d. A further application is the derivation of d from a requested (or specified) change in the mean observed rating, when the rating levels are assigned the numerical values 1, 2, . . . , K.

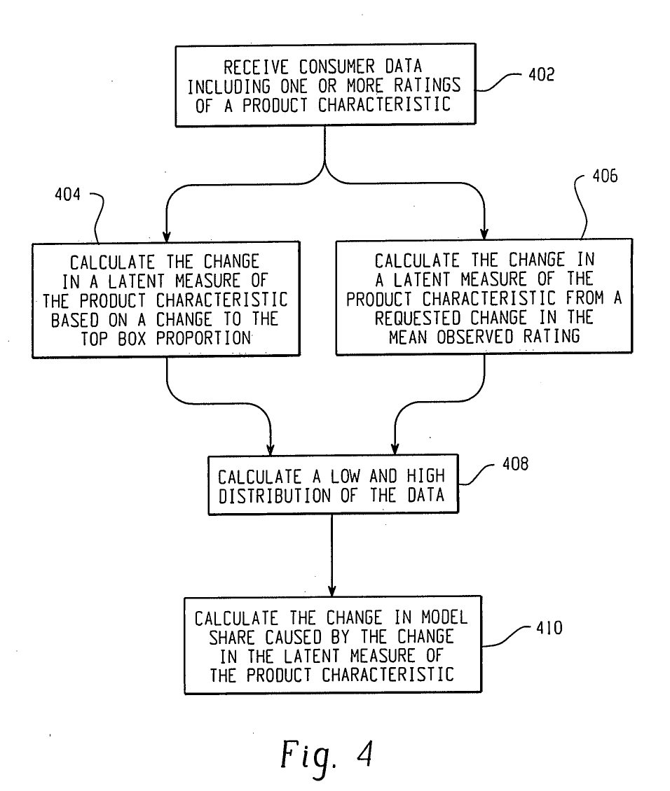

A process that may be implemented to perform the alternate sensitivity analysis algorithm is depicted in FIG. 4. At block 402, consumer data including one or more ratings of a product characteristic is received. These ratings reflect a latent measure of the product characteristic. The consumer data is then represented as a probability distribution. Processing then continues at either block 404 or 406 depending on a selection (e.g., via a user interface screen) made by the user.

At block 404, the change in a latent measure of the product characteristic (d) is calculated based on a specified (e.g., by the user) change to the top-box proportion of the probability distribution.

The exemplary described herein calculation is based on a requested decrease in the top-box proportion. To simplify the notation, define

$${P}_{k}^{*} = \frac{{P}_{k} + k ɛ}{1 + K ɛ} , k = 1 , … , K - 1 ,$$

where ε is a parameter of the algorithm (defined above).

To decrease the top-box proportion, pk, by an amount, δ assume that min(p_{K}, 1−p_{K})>δ>0, so that the top-box proportion can be increased or decreased by δ without making it negative or greater than 1. Applying equations (11)-(13), below, from the algorithm, it can be seen that

$$\begin{matrix}{p}_{\overline{K}} = {p}_{K} - δ & \\ = 1 - {P}_{\overline{K} - 1} & by definition of {p}_{K} \\ = 1 - min [ 1 , {P}_{K - 1} + {P}_{K - 1}^{*} ( 1 - {P}_{K - 1}^{*} ) d ] & \begin{matrix}by equation ( 2 ) and \\ the definition of Δ\end{matrix} \\ = max [ 0 , {p}_{K} - {P}_{K - 1}^{*} ( 1 - {P}_{K - 1}^{*} ) d ] & \\ = {p}_{K} - {P}_{K - 1}^{*} ( 1 - {P}_{K - 1}^{*} ) d & since 0 < δ < {p}_{K}\end{matrix}$$

Using the above result to solve for d:

$$d = \frac{δ}{{P}_{K - 1}^{*} ( 1 - {P}_{K - 1}^{*} )} .$$

This value of d can then be used to calculate the p⁻ and p⁺ distributions. Processing then continues at block 408.

At block 406, the change in a latent measure of the product characteristic is calculated based on specified change to a mean of the ratings product characteristic. At block 406, the change in d (the change in the latent variable) is calculated from a requested change in the mean observed rating.

The “mean observed rating” is defined in terms of the cumulative proportions:

$$\overline{y} = {\sum }_{k = 1}^{K} ( {P}_{k} - {P}_{k - 1} ) k , {P}_{k} = {\sum }_{i = 1}^{k} {p}_{i} , . \qquad ( 7 )$$

In words, the values 1, . . . , K are assigned to the K ordered values of yₙ, and then averaged over all raters of the given vehicle.

When F is the standardized Logistic cdf,

$$\begin{matrix}{P}_{k} ( d ) = F ( \tilde{μ} + ( \sqrt{3} / π ) d ) \\ \approx F ( \tilde{μ} ) - \frac{ⅆ F}{ⅆ ( \tilde{μ} )} ( \sqrt{3} / π ) d \\ \approx {P}_{k} - {P}_{k}^{*} ( 1 - {P}_{k}^{*} ) d\end{matrix} \qquad ( 8 )$$

where \tilde{μ}=the standardized mean of the latent attribute, and
(\sqrt{3}/π)d=change in \tilde{μ}.

Note that the derivative in equation (8) is computed using the smoothed cumulative probabilities, Pₖ*, k=1, . . . , K, in order to prevent potential numerical problems.

If \tilde{μ} is the baseline mean of the latent variable and the Pₖ(=Pₖ(0)) in equation (7) are the baseline cumulative proportions, then the change in the observed mean due to a change in \tilde{μ} can be written as follows:

$$\begin{matrix}\overline{y} ( d ) - \overline{y} = {\sum }_{k = 1}^{K} ( {P}_{k} ( d ) - {P}_{k - 1} ( d ) ) k - {\sum }_{k = 1}^{K} ( {P}_{k} - {P}_{k - 1} ) k \\ = {\sum }_{k = 1}^{K} [ ( {P}_{k} ( d ) - {P}_{k} ) - ( {P}_{k - 1} ( d ) - {P}_{k - 1} ) ] k \\ \approx {\sum }_{k = 1}^{K} [ {P}_{k}^{*} ( 1 - {P}_{k}^{*} ) - {P}_{k - 1}^{*} ( 1 - {P}_{k - 1}^{*} ) ] dk\end{matrix} \qquad ( 9 )$$

The value of d that approximately yields a given change in the observed mean can be computed by setting the left hand side of (9) equal to the given change and solving for d. If this value for d is used in equation (11), then the change in observed mean in the direction of d should be close to the target. The change in the observed mean in the opposite direction, however, may not be exactly the same magnitude.

Since the procedure in equations (11)-(13), below, produces both a “high” and a “low” distribution, it may be preferable to compute a value for d that yields a specified difference between the high mean and the low mean. To do this, specify a value for the left hand side of (10) and solve for d:

$$\begin{matrix}\overline{y} ( d ) - \overline{y} ( - d ) = {\sum }_{k = 1}^{K} ( {P}_{k} ( d ) - {P}_{k - 1} ( d ) ) k - {\sum }_{k = 1}^{K} ( {P}_{k} ( - d ) - {P}_{k - 1} ( - d ) ) k \\ = {\sum }_{k = 1}^{K} [ ( {P}_{k} ( d ) - {P}_{k} ( - d ) ) - ( {P}_{k - 1} ( d ) - {P}_{k - 1} ( - d ) ) ] k \\ \approx {\sum }_{k = 1}^{K} [ {P}_{k - 1}^{*} ( 1 - {P}_{k - 1}^{*} ) - {P}_{k}^{*} ( 1 - {P}_{k}^{*} ) ] 2 dk\end{matrix} \qquad ( 10 )$$

When the value of d computed by solving (9) is used in equation (11), the increase in the observed mean for the “high”, distribution may differ in magnitude somewhat from the decrease in the observed mean for the “low” distribution, but the total spread between the high and the low observed mean should be very close to that specified for the left hand side of (9). Processing then continues at block 408.

At block 408, a low and high distribution of the data is calculated based on the calculated change in the latent measure of the product characteristic. Given the baseline distribution of ratings (e.g., from a database with product data), p=(p₁, p₂, . . . p_{K}), block 408 calculates a “low” distribution, p⁻, and a “high” distribution, p+, as follows:
1. The procedure requires two parameters, ε and d. Their function is described below; and in exemplary embodiments initial settings are ε=0.1 and, d=0.15. As described previously (the parameter d can easily be varied).
2. In all of the following formulas, cumulative proportions are denoted by Pₖ=Σᵢ₌₁^{k}pₖ, k=1, . . . , K−1, and P₀=0 and P_{K}=1.
3. Compute the changes to be made to the baseline cumulative proportions in order to get the low and high distributions:

$${Δ}_{k} = [ \frac{{P}_{k} + k ɛ}{1 + K ɛ} ] [ 1 - \frac{{P}_{k} + k ɛ}{1 + K ɛ} ] d , k = 1 , … , K - 1 , \qquad ( 11 )$$
4. Compute the low and high cumulative proportions using the following recursive formulas:
   Pₖ⁻=min(Pₖ₊₁⁻,Pₖ+Δₖ), k=K−1, . . . , 1
   Pₖ⁺=max(Pₖ₋₁⁺,Pₖ−Δₖ), k=1, . . . , K−1 (12)
5. Compute the low and high distributions (recall that P₀=0 and P_{K}=1):
   pₖ⁻=Pₖ⁻−Pₖ₋₁⁻, pₖ⁺=Pₖ⁺−Pₖ₋₁⁺, k=1, . . . , K (13)

The above procedure approximates the behavior of the latent variable model when the distribution of perceived performance is logistic. That is, the formula for Δ in equation (11) is approximately equal to the change in the cumulative proportion that occurs in the logistic latent variable model. (The mathematical derivation is omitted here.) The smoothing parameter ε in equation (11) prevents the occurrence of Δₖ=0 due to small sample variability. While ε should probably be held fixed, the parameter d can be varied to change the spread between p⁺ and p⁻. The formulas in equation (12) ensure that the cumulative proportions in P⁻ and P⁺ are nondecreasing. Manners of setting the parameter d that can make use of historical data to decide what is reasonable were described previously in reference to blocks 404 and 406 in FIG. 4.

At block 410, elasticities for the subjective attributes are calculated by calculating the change in product share caused by the change in d of the product characteristic. The “mean observed rating” is defined in terms of the cumulative proportions defined above:

$$\overline{y} = {\sum }_{k = 1}^{K} ( {P}_{k} - {P}_{k - 1} ) k , \\ {P}_{k} = {\sum }_{i = 1}^{k} {p}_{i} , . \qquad ( 7 )$$

In words, the values 1, . . . , K are assigned to the K ordered values of yₙ, and then averaged over all raters of the given vehicle.

When F is the standardized Logistic cdf, it can be written as:

$$\begin{matrix}{P}_{k} ( d ) = F ( \tilde{μ} + ( \sqrt{3} / π ) d ) \\ \approx F ( \tilde{μ} ) - \frac{ⅆ F}{ⅆ ( \tilde{μ} )} ( \sqrt{3} / π ) d \\ \approx {P}_{k} - {P}_{k}^{*} ( 1 - {P}_{k}^{*} ) d\end{matrix} \qquad ( 8 )$$

where \tilde{μ}=the standardized mean of the latent attribute, and
(\sqrt{3}/π)d=change in \tilde{μ}.

Note that the derivative in equation (8) is computed using the smoothed cumulative probabilities in order to prevent potential numerical problems.

If \tilde{μ} is the baseline mean of the latent variable and the Pₖ(=Pₖ(0)) in equation (7) are the baseline cumulative proportions, then the change in the observed mean due to a change in \tilde{μ} can be written as follows:

$$\begin{matrix}\overline{y} ( d ) - \overline{y} = {\sum }_{k = 1}^{K} ( {P}_{k} ( d ) - {P}_{k - 1} ( d ) ) k - {\sum }_{k = 1}^{K} ( {P}_{k} - {P}_{k - 1} ) k \\ = {\sum }_{k = 1}^{K} [ ( {P}_{k} ( d ) - {P}_{k} ) - ( {P}_{k - 1} ( d ) - {P}_{k - 1} ) ] k \\ \approx {\sum }_{k = 1}^{K} [ {P}_{k}^{*} ( 1 - {P}_{k}^{*} ) - {P}_{k - 1}^{*} ( 1 - {P}_{k - 1}^{*} ) ] dk\end{matrix} \qquad ( 9 )$$

The value of d that approximately yields a given change in the observed mean by setting the left hand side of (9) equal to the given change and solving for d. If this value for d is used in equation (11), then the change in observed mean in the direction of d should be close to the target. The change in the observed mean in the opposite direction, however, may not be exactly the same magnitude.

Since the procedure in equations (11)-(13) produces both a “high” and a “low” distribution, it may be preferable to compute a value for d that yields a specified difference between the high mean and the low mean. To do this, specify the left hand side of (10) and solve for d:

$$\begin{matrix}\overline{y} ( d ) - \overline{y} ( - d ) = {\sum }_{k = 1}^{K} ( {P}_{k} ( d ) - {P}_{k - 1} ( d ) ) k - {\sum }_{k = 1}^{K} ( {P}_{k} ( - d ) - {P}_{k - 1} ( - d ) ) k \\ = {\sum }_{k = 1}^{K} [ ( {P}_{k} ( d ) - {P}_{k} ( - d ) ) - ( {P}_{k - 1} ( d ) - {P}_{k - 1} ( - d ) ) ] k \\ \approx {\sum }_{k = 1}^{K} [ {P}_{k - 1}^{*} ( 1 - {P}_{k - 1}^{*} ) - {P}_{k}^{*} ( 1 - {P}_{k}^{*} ) ] 2 dk\end{matrix} \qquad ( 10 )$$

When the value of d computed by solving (10) is used in equation (11), the increase in the observed mean for the “high” distribution may differ in magnitude somewhat from the decrease in the observed mean for the “low” distribution, but the total spread between the high and the low observed mean should be very close to that specified for the left hand side of (10).

For any value of d, the distributions p⁻ and p⁺ are computed using the algorithm and used to calculate a percentage change in either top-box proportion or mean rating. Let s⁻ and s⁺ denote the model share of a vehicle given the subjective attribute rating distributions p⁻ and p⁺, respectively. The arc-elasticity of the share of the vehicle with respect to the top-box proportion is given by:

$$E = \frac{\frac{{s}^{+} - {s}^{-}}{\frac{1}{2} ( {s}^{+} + {s}^{-} )}}{\frac{{p}_{K}^{+} - {p}_{K}^{-}}{\frac{1}{2} ( {p}_{K}^{+} + {p}_{K}^{-} )}}$$

Note that, if desired, d can be chosen to yield a certain change in the top-box proportion, and the sensitivity of model share to changes in the subjective attribute can be expressed as an elasticity using the above equation.

To compute the elasticity with respect to the mean rating, the mean ratings implied by p⁻ and p⁺ are calculated and substitute these for the top-box proportions in the above formula.

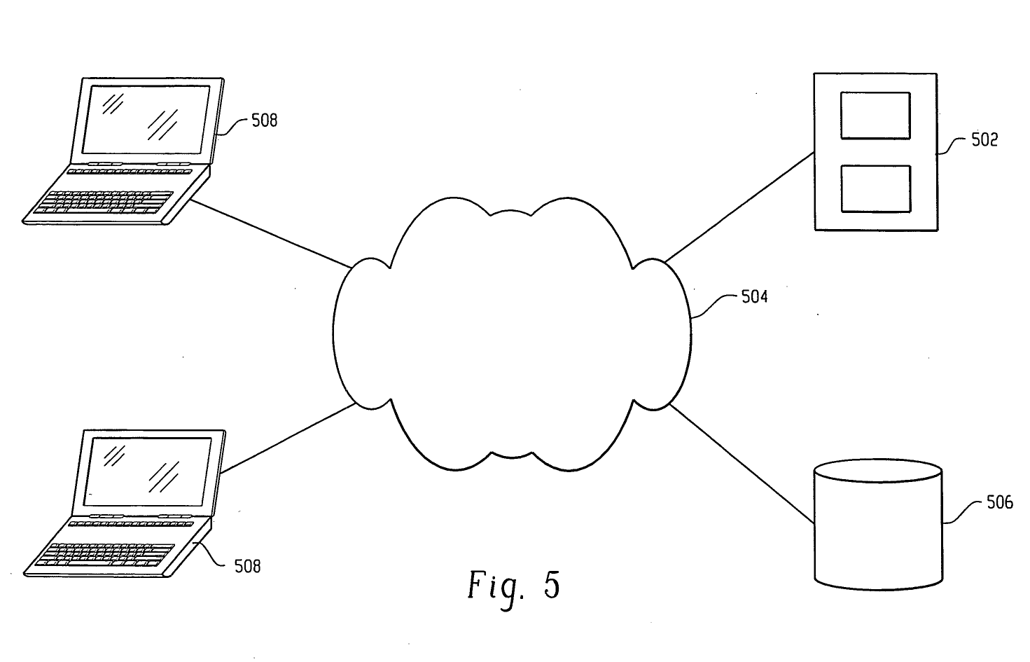

FIG. 5 depicts a system for performing market simulation that may be implemented by exemplary embodiments. Exemplary embodiments are implemented as market simulation software (e.g., computer instructions) executing on a host system 502. The host system 502 may include one or more user systems 508 through which users at one or more geographic locations may contact the host system to execute the simulation software to perform one or more of the processes described herein. In exemplary embodiments, the user systems 508 are coupled to the host system 502 via a network 504 and each user system 508 may be implemented using a general-purpose computer executing a computer program for carrying out the processes described herein. The user systems 508 may be implemented by personal computers and/or host attached terminals and may display user interface screens associated for with the market simulation software for entering and displaying data. If the user systems 508 are personal computers (or include functionality to execute the processing described herein), the processing described herein may be shared by a user system 508 and the host system 502 (e.g., by providing an applet to the user system). In alternate exemplary embodiments, the simulation software is located on the user system 508 and the processing described herein is performed by the user system 508.

The network 504 may be any type of known network including, but not limited to, a wide area network (WAN), a local area network (LAN), a global network (e.g. Internet), a virtual private network (VPN), and an intranet. The network 504 may be implemented using a wireless network or any kind of physical network implementation. A user system 508 may be coupled to the host system 502 through multiple networks 504 (e.g., intranet and Internet) so that not all user systems 508 are coupled to the host system 502 through the same network 504. One or more of the user systems 508 and the host system 502 may be connected to the network 504 in a wireless fashion.

Exemplary embodiments include a storage device 506 (in communication with the network, user system and/or host system) for storing data associated with the market simulation software and process. The storage device 506 may be implemented using a variety of devices for storing electronic information. It is understood that the storage device 506 may be implemented using memory contained in the host system 502, a user system 508, or it may be a separate physical device. The storage device 506 is logically addressable as a consolidated data source across a distributed environment that includes a network 504. Information stored in the storage device 506 may be retrieved and manipulated via the host system 502 and/or via one or more user systems 508. In exemplary embodiments of the present invention, the host system 502 operates as a database server and coordinates access to application data including data stored on the storage device.

The host system 502 may be implemented using one or more servers operating in response to a computer program stored in a storage medium accessible by the server. The host system 502 may operate as a network server (e.g., a web server) to communicate with the user systems 508. The host system 502 handles sending and receiving information to and from the user system 508 and can perform associated tasks. The host system 502 may also include a firewall to prevent unauthorized access to the host system 502 and enforce any limitations on authorized access. A firewall may be implemented using conventional hardware and/or software as is known in the art.

The host system 502 may also operate as an application server. The host system 502 executes one or more computer programs to implement the market simulation functions described herein. Processing may be shared by the user system 508 and the host system 502 by providing an application (e.g., java applet) to the user system 508.

Alternatively, the user system 508 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

Technical effects and benefits include the ability to differentiate between alternate product designs in terms of the market appeal of their subjective characteristics.

As described above, the embodiments of the invention may be embodied in the form of hardware, software, firmware, or any processes and/or apparatuses for practicing the embodiments. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for performing market simulation, the method comprising:
receiving consumer data including one or more ratings of a product characteristic, the ratings reflecting a latent measure of the product characteristic;
representing the ratings as a probability distribution;
varying the latent measure of the product characteristic;
creating an updated probability distribution in response to the varying; and
analyzing a sensitivity of market share to the product characteristic, the analyzing responsive to the probability distribution and to the updated probability distribution.

2. The method of claim 1 wherein the product characteristic is a subjective performance attribute.

3. The method of claim 1 wherein the ratings are on an ordinal scale.

4. The method of claim 1 wherein the latent measure is on a continuous scale.

5. The method of claim 1 wherein the probability distribution is a normal curve.

6. The method of claim 1 wherein the probability distribution includes continuous values.

7. The method of claim 1 wherein the probability distribution includes discrete values.

8. The method of claim 1 wherein the latent measure is a latent perceived performance of the product characteristic.

9. The method of claim 1 wherein the analyzing is performed using a latent variable based statistical model.

10. The method of claim 1 further comprising comparing the sensitivity of market share to the product characteristics of two or more products.

11. A method for performing market simulation, the method comprising:
receiving consumer data including one or more ratings of a product characteristic, the ratings reflecting a latent measure of the product characteristic;
representing the ratings as a probability distribution;
calculating a change to the latent measure of the product characteristic based on a specified change to a top-box proportion of the probability distribution or based on a specified change to a mean observed rating of the product characteristic;
calculating a low distribution of the data in response to the calculated change in the latent measure;
calculating a high distribution of the data in response to the calculated change in the latent measure; and
calculating change in product share caused by the change in the latent measure of the product characteristic in response to the low and high distributions of the data.

12. The method of claim 11 wherein the product characteristic is a subjective performance attribute.

13. The method of claim 11 wherein the ratings are on an ordinal scale.

14. The method of claim 11 wherein the latent measure is on a continuous scale.

15. The method of claim 11 wherein the probability distribution includes continuous values.

16. The method of claim 11 wherein the latent measure is a latent perceived performance of the product characteristic.

17. A computer program product for performing market simulation, the computer program product comprising:
a storage medium readable by a processing circuit and storing instructions for execution by the processing circuit for performing a method comprising:
receiving consumer data including one or more ratings of a product characteristic, the ratings reflecting a latent measure, of the product characteristic;
representing the ratings as a probability distribution;
varying the latent measure of the product characteristic;
creating an updated probability distribution in response to the varying; and
analyzing a sensitivity of market share to the product characteristic, the analyzing responsive to the probability distribution and to the updated probability distribution.

18. The computer program product of claim 17 wherein the product characteristic is a subjective performance attribute.

19. The computer program product of claim 17 wherein the ratings are on an ordinal scale.

20. The computer program product of claim 17 wherein the latent measure is on a continuous scale.
